(19) United States
(12) Patent Application Publication
(10) Pub. No.: US 2013/0310950 A1
(43) Pub. Date: Nov. 21, 2013

(54) METHOD OF SIMULTANEOUSLY CONNECTING CONTROLLERS OF DIFFERENT BRANDED MANUFACTURING MACHINES

(71) Applicants: FENG-CHING CHIANG, TAICHUNG (TW); KO-CHANG YAO, CHANGHUA COUNTY (TW); SHENG-JHE CHEN, CHANGHUA COUNTY (TW)

(72) Inventors: FENG-CHING CHIANG, TAICHUNG (TW); KO-CHANG YAO, CHANGHUA COUNTY (TW); SHENG-JHE CHEN, CHANGHUA COUNTY (TW)

(73) Assignee: PRECISION MACHINERY RESEARCH & DEVELOPMENT CENTER, TAICHUNG (TW)

(21) Appl. No.: 13/471,545

(22) Filed: May 15, 2012

(51) Int. Cl. G05B 19/048

(52) U.S. Cl. 700/2

(57) ABSTRACT

A method of simultaneously connecting controllers of different branded manufacturing machines applied in a computer system. The computer system includes an integrated running module, a user interface interacted with the integrated running module, a plurality of application program interfaces integrated in the integrated running module and communicated with the controllers of specific brands respectively, such that the integrated running module can be connected to the controller corresponding to each of the application program interfaces at the same time. The method includes the steps of selecting the manufacturing machine to be connected through the user interface, producing a thread by the integrated running module according to the application program interface corresponding to the controller of each manufacturing machine, and retrieving required information from the corresponding controller by the integrated running module through each thread.

### BACKGROUND OF THE INVENTION

1. Field of the Invention

The present invention relates to a method of connecting manufacturing machines, and more particularly to the method of simultaneously connecting controllers of different branded manufacturing machines.

2. Description of Related Art

As information technology advances, remote monitor and control have become very popular and extensively used in CNC manufacturing machines. In particular, network transmissions become increasingly more popular, so that different branded manufacturing machines are equipped with a controller having the network transmission function. As long as the controller with the network transmission function is chosen, computers or other equipments can be used for remote monitor and control operations.

However, there are different models of controllers for various branded manufacturing machines, and the way of using libraries of different models and brands varies, and each branded controller comes with proprietary remote communication interface. In other words, manufacturers have their own interfaces respectively, and users need to be familiar with the communication interface of each manufacturer before the users can connect to the controllers of different manufacturers, and thus application developers have troubles on developing related software. A general manufacturing factor usually has different models of controllers and various branded manufacturing machines, and the model number of the controller of each manufacturer comes with a corresponding application program interface (API) and different branded controllers are connected in different ways, and thus causing tremendous inconvenience to the integrated operation of the manufacturers.

### SUMMARY OF THE INVENTION

In view of the aforementioned problem of the prior art, it is a primary objective of the present invention to provide an integrated running module that can be connected to a web services runtime, and the web services runtime maintains an online status with a remote server automatically through a network, and the web services runtime can transmit information captured by the integrated running module to the remote server. After the integrated running module is connected with a predetermined controller, the web services runtime will automatically connect to the remote server, such that a user can start a browser to link to a web page created by the remote server. After selecting a specific option in the web page, the remote server will call the web services runtime to request the integrated running module to send predetermined information to the remote server.

### BRIEF DESCRIPTION OF THE DRAWINGS

FIG. 1 is a schematic view of a structure of the present invention;

FIG. 2 is a flow chart of an integrated running module used for simultaneously connecting several branded manufacturing machine controllers in accordance with the present invention;

FIG. 3 is a schematic view of uploading or downloading an NC program in accordance with the present invention;

FIG. 4 is a schematic view of a structure of uploading or downloading an NC program in accordance with the present invention;

FIG. 5 is a flow chart of executing a common function runtime in accordance with the present invention;

FIG. 6 is a flow chart of executing a common function runtime and an application drafted with an XML format in accordance with the present invention;

FIG. 7 is a flow chart of a web services runtime in accordance with the present invention.

FIG. 8 is a schematic view of an application of a web services runtime in accordance with the present invention.

### DETAILED DESCRIPTION OF THE PREFERRED EMBODIMENTS

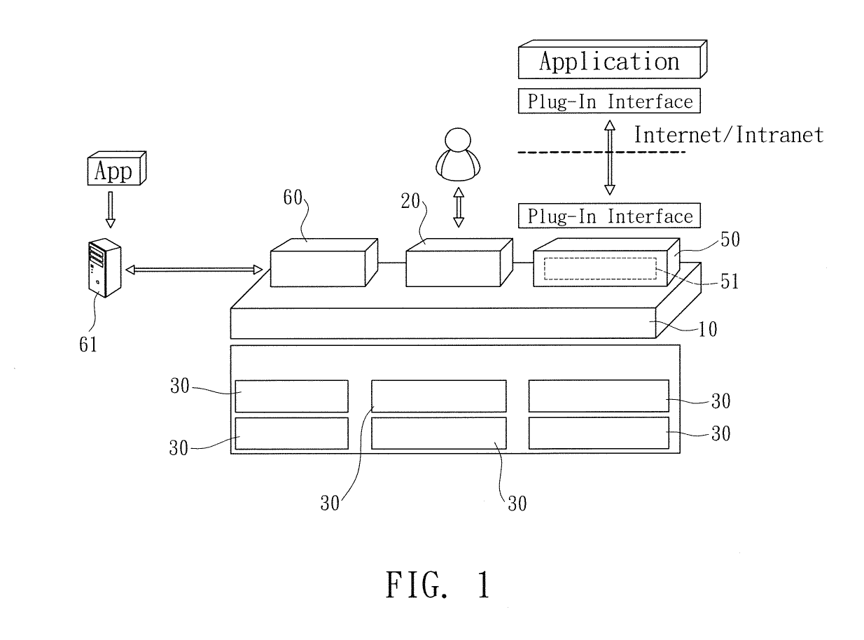

The present invention discloses a method of simultaneously connecting controllers of different branded manufacturing machines, and the method is applied in a computer system as shown in FIG. 1, and the computer system comprises an integrated running module 10, a user interface (UI) 20 interacted with the integrated running module 10, a plurality of application program interfaces (API) 30 integrated in the integrated running module 10 for communicating with a controller of a specific branded manufacturing machine including the manufacturing machine controllers with the brand of FANUC, MITSUBISHI, or SIEMENS, so that the integrated running module 10 can be connected to the controller of each of the application program interfaces 30 at the same time, and the integrated running module 10 can be connected and communicated with the application program interface of the corresponding controller, and the integrated running module 10 produces a thread according to the application program interface 30 corresponding to the controller of each of the manufacturing machines. Wherein, the computer system further includes a global memory area and a utilization database (not shown in the figure), and each thread can be used to detect a machine status of the corresponding manufacturing machine, and the machine status includes utilization information such as OFF, IDLE, RUN and ALARM, and the status detected by the integrated running module 10 is saved to the global memory area, provided for displaying by the user interface 20, and recorded to the utilization database.

The integrated running module 10 is coupled to a common function runtime (CFR) 50, such that after the integrated running module 10 is integrated with each of the application program interfaces 30, a common application program interface 51 is created and installed in the common function runtime 50. The common function runtime 50 includes a plug-in interface which is an interface DLL file used for defining a function name and a data structure of the common function runtime 50 and provided for users to add references and create namespace to call and use the common function runtime 50.

The integrated running module 10 is coupled to a web services runtime (WSR) 60, and the web services runtime 60 maintains an online status with a remote server 61 through a network automatically, and the web services runtime 60 transmits the information retrieved by the integrated running module 10 to the remote server 61.

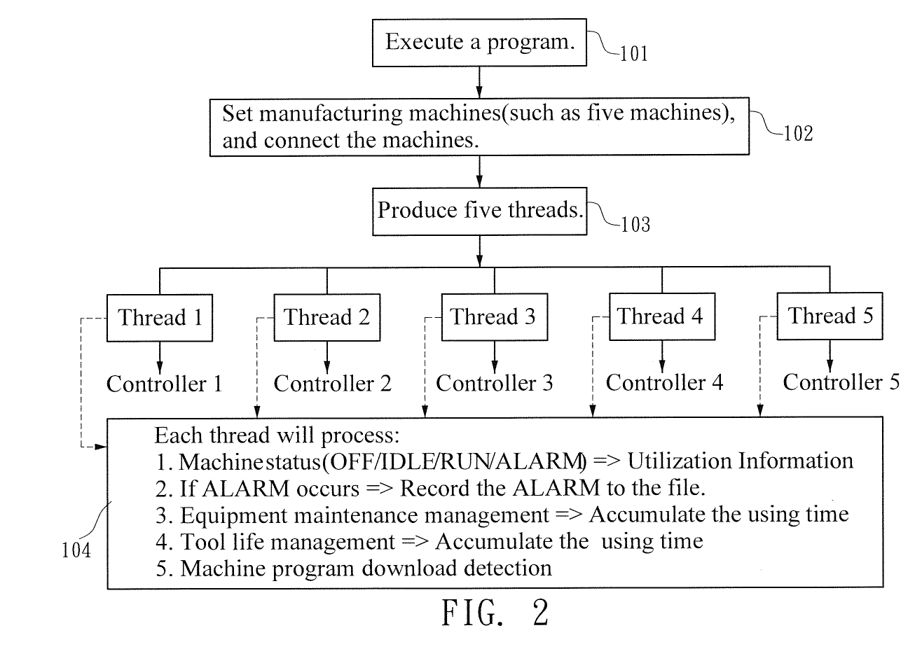

With reference to FIG. 2 for a flow chart of a method of simultaneously connecting controllers of different branded manufacturing machines in accordance with the present invention, the method comprises the following steps:

(101): Execute a program.

(102): Select a controller 40 of a manufacturing machine to be connected through the user interface 20.

(103): Produce a thread by the integrated running module 10 according to the application program interface 30 of each controller 40 of the manufacturing machines.

(104): Retrieve required information from the controller 40 of the corresponding manufacturing machine through each thread by the integrated running module 10, and the retrieved information is utilization information including OFF, IDLE, RUN, and ALARM.

Based on the aforementioned method, if the ALARM status occurs, the integrated running module 10 will save the ALARM message as an XML text file automatically and provide the XML text file for the use by the user interface 20 during the process of examining the ALARM.

Based on the aforementioned method, after the manufacturing machine is turned on, the integrated running module 10 will accumulate the time of using the manufacturing machine through the corresponding controller 40 automatically to perform an equipment maintenance management.

Based on the aforementioned method, after the manufacturing machine is turned on, and situated at the RUN status, the integrated running module 10 will accumulate the RUN time of using the manufacturing machine through the corresponding controller 40 automatically to perform a knife life management.

Based on the aforementioned method, each thread uploads a part program to the controller 40 of the corresponding manufacturing machine.

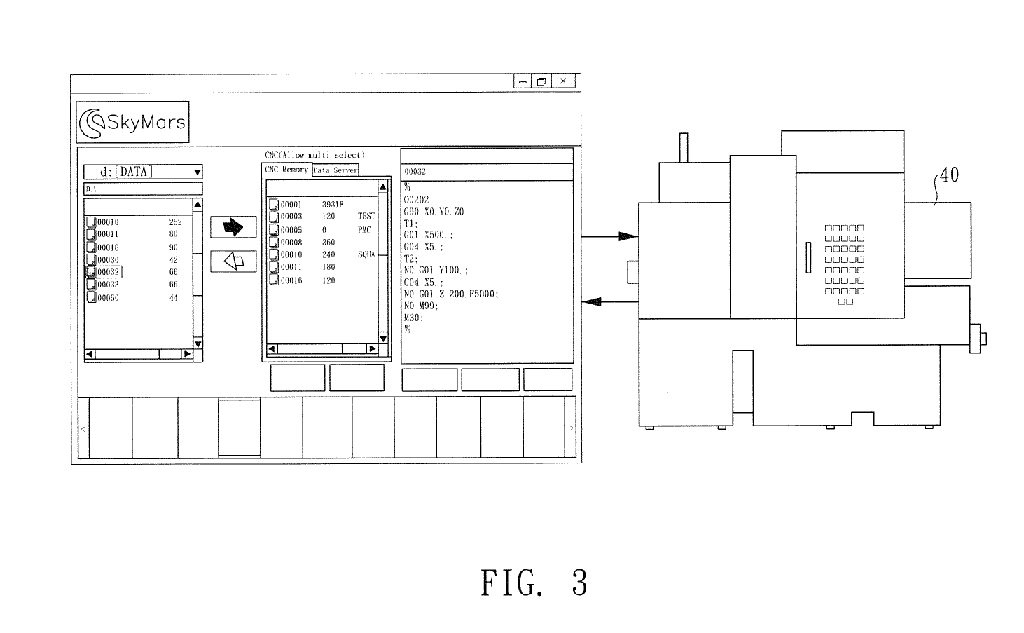

Therefore, after a remote user can use a part program editor or a computer aided manufacture (CAM) to transfer the part program code, the integrated running module 10 provides the functions of directly uploading and downloading the part program, so as to upload the part program to the controller 40 of the corresponding manufacturing machine as shown in FIG. 3. After the part program is selected, the right arrow is pressed to upload the part program. After the part program is uploaded successfully, the controller 40 of the manufacturing machine can read the part program.

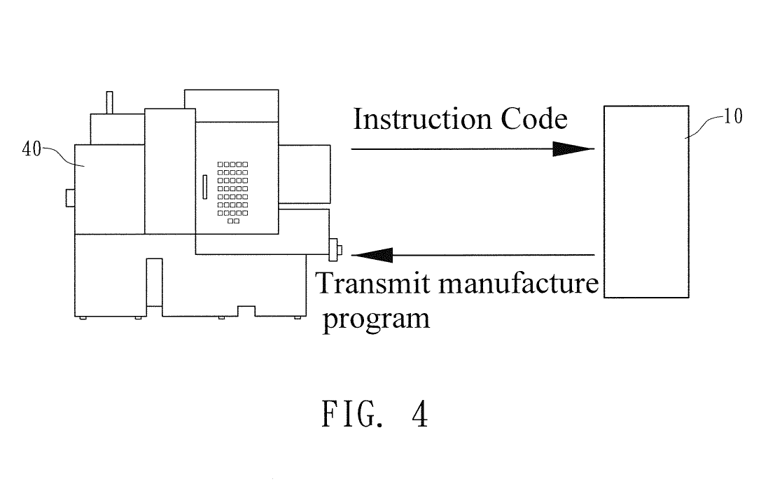

After a factory worker sets a workpiece in front of the manufacturing machine, the system allows the factory worker to input related instruction codes from the controller 40 of the manufacturing machine directly without the need of operating at the computer end, so as to automatically upload the part program controlled by the integrated running module 10 to the controller of the manufacturing machine, and the factory worker can directly load the part program to perform the manufacture. The operation of this sort considers the integrated running module 10 as a part program server (as shown in FIG. 4). According to this setup, the integrated running module 10 can be installed to the main file server of a company, and then the specific address of the part program of the integrated running module 10 is pointed at a data folder. Now, after the integrated running module 10 is turned on, the instruction code of the controller will be monitored real time. If it is necessary to upload the instruction code of the part program, the integrated running module 10 will read the specified part program, and directly upload the instruction code to the controller 40 of the manufacturing machine.

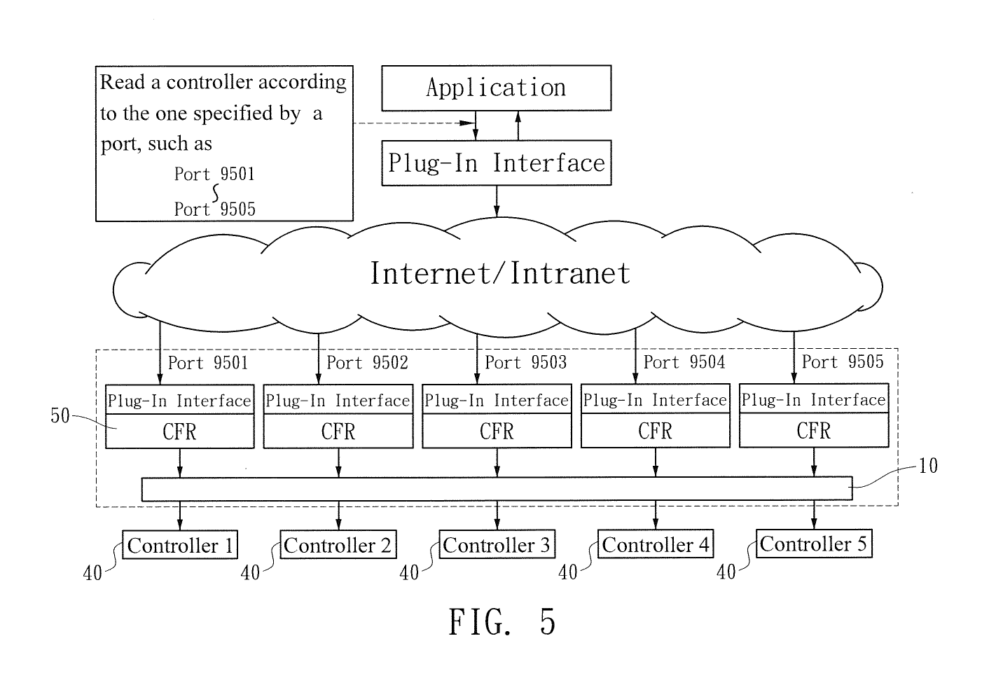

In FIG. 5, after the integrated running module 10 is connected to the controller 40 of the predetermined manufacturing machine, the integrated running module 10 will create a corresponding common application program interface 51 of the common function runtime(CFR) 50 according to each thread, and provide the common application program interface 51 for a developer to call a function and introduce a data structure defined by the plug-in interface according to the function defined by the plug-in interface, and draft a micro application (App), and the micro application is transmitted to the common function runtime 50 via a network, and the common function runtime 50 is responsible for obtaining required information from the controller 40 of the corresponding manufacturing machine, and the information obtained by the common function runtime 50 is saved in the data structure defined by the plug-in interface and returned to the micro application.

Therefore, developers can draft or expand the micro application on their own, since the common function runtime 50 and the plug-in interface allow the developers to use the function name and data structure defined by the plug-in interface without the need of knowing the application program interfaces (API) of the controllers of different brands, so as to decrease the number of program codes significantly and achieve the effect of developing the application quickly. Each customized micro application can be developed according to the different requirements to provide very convenient operations for users.

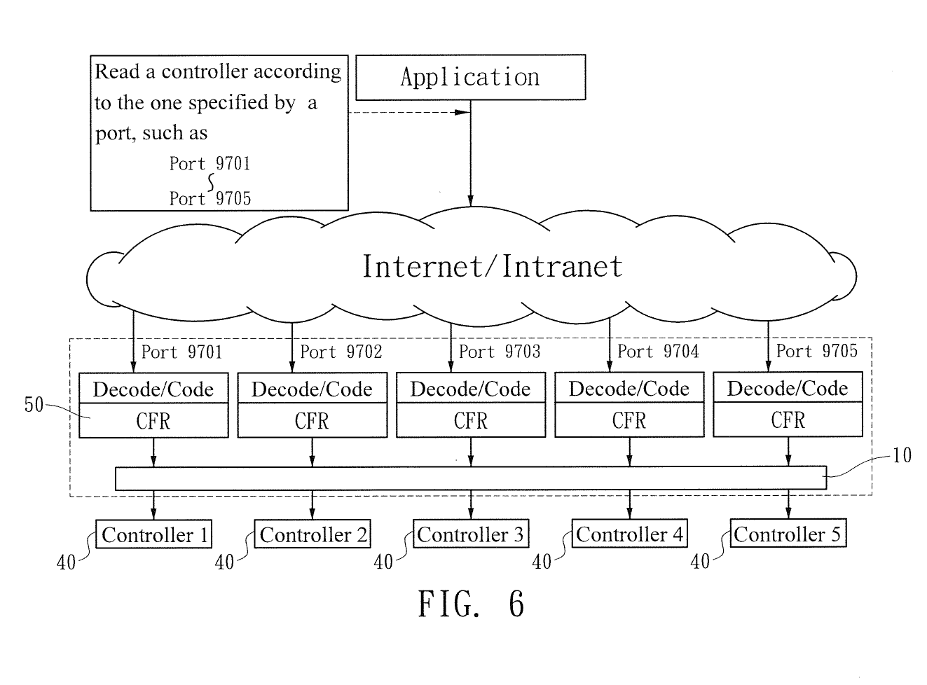

With reference to FIG. 6 for a flow chart of executing a common function runtime and an application drafted with an XML format in accordance with the present invention, the XML format is used for drafting the micro application. Similarly, the micro application is transmitted to the common function runtime 50 via a network, decoded by the common function runtime 50, and used for directly communicating with the integrated running module 10 to obtain required information from the controller 40 of the corresponding manufacturing machine and the obtained information is encoded by the common function runtime 50 and then returned to the micro application.

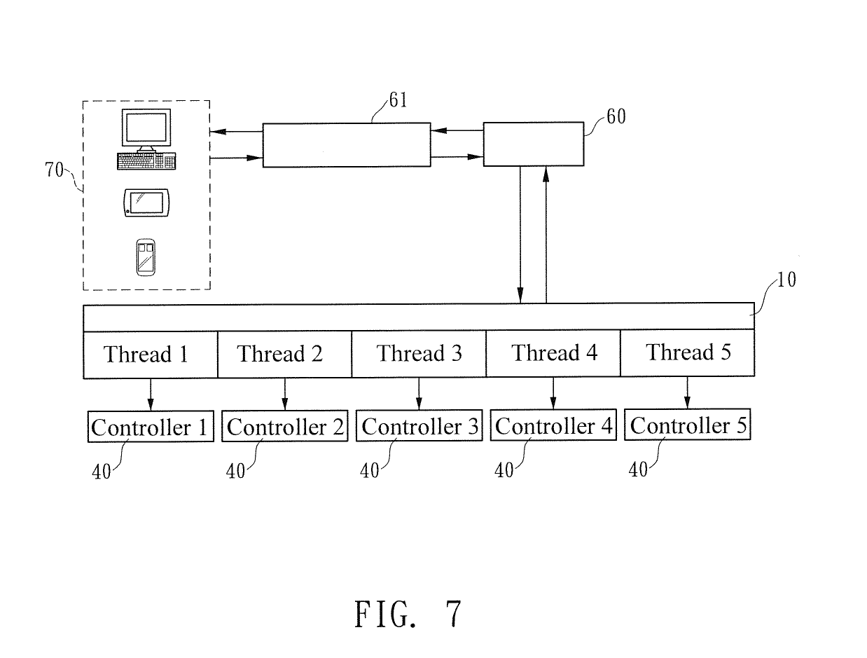

In FIG. 7, after the integrated running module 10 is connected to a predetermined controller 40 of the manufacturing machine, the web services runtime (WSR) 60 will automatically connect to the remote server 61, such that a user side 70 can turn on a browser to link to a web page constructed by the remote server 61, and after a specific option of the web page is selected, the message is transmitted to a service cache of the remote server 61, so that when the web services runtime 60 retrieves the service cache, the web services runtime 60 can obtain information of each thread from the integrated running module 10, and then transmit the information to the service cache of the remote server 61, and the information is provided for the user side 70 to retrieve and display on the web page.

Wherein, the user side 70 can be a desktop computer, a notebook computer, a tablet PC or a smart phone.

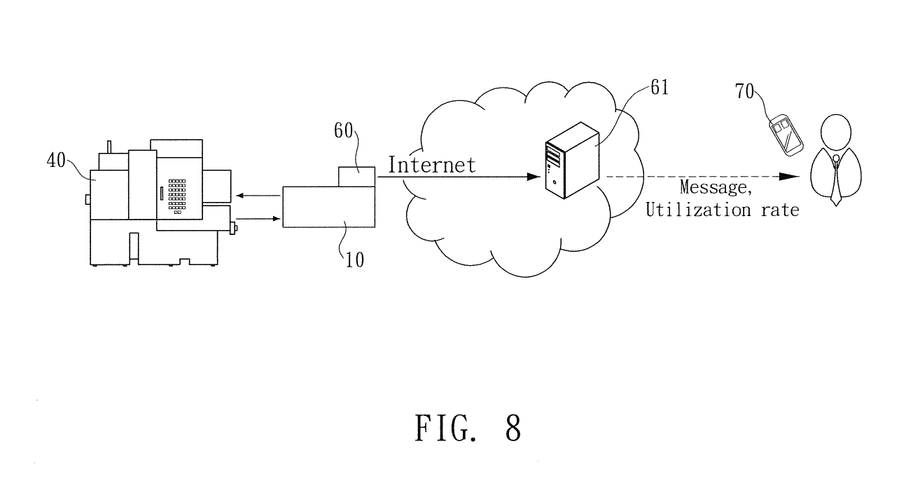

In FIG. 8, when the operation of counting the utilization, the integrated running module 10 can obtain the machine status, the quantity of workpieces and manufacturing time of each manufacturing machine real time, and save the information into the utilization database, such that when a utilization inspector needs to inspect the machines, the data in the utilization database can be retrieved through the remote server 61 and used for performing the statistical operation to facilitate the manufacturers to find the machines with low efficiency and their causes, so as to improve the performance of the manufacturing machines.

In addition, after the integrated running module 10 is connected to the predetermined controller 40 of the manufacturing machine, the web services runtime 60 will automatically obtain information of each thread from the integrated running module 10 and transmit the information to a service cache of the remote server 61, and when the remote server 61 receives a manufacturing machine alarm message, the remote server 61 will actively transmit a message to the user side 70 via the network.

It is noteworthy that the micro application (App) drafted according to different requirements can be saved in the remote server 61 and provided for users to download, installed and use as shown in FIG. 1.

What is claimed is:

1. A method of simultaneously connecting controllers of different branded manufacturing machines, applied in a computer system, and the computer system comprising an integrated running module, a user interface interacted with the integrated running module, a plurality of application program interfaces (API) integrated in the integrated running module and communicated with the controllers of specific branded manufacturing machines respectively, such that the integrated running module can be connected to the controller corresponding to each of the application program interfaces, and the method comprising the steps of selecting the manufacturing machine to be connected through the user interface, and producing a thread by the integrated running module according to the application program interface corresponding to the controller of each of the manufacturing machines, and retrieving required information from the corresponding controller by the integrated running module.

2. The method of simultaneously connecting controllers of different branded manufacturing machines as recited in claim 1, wherein the computer system further comprises a global memory area and a utilization database, and each thread can detect a machine status of the corresponding manufacturing machine, and the machine status includes utilization information selected from the collection of OFF, IDLE, RUN and ALARM, and the integrated running module saves the detected machine status in the global memory area, provides the machine status to the user interface for a display, and records the machine status in the utilization database.

3. The method of simultaneously connecting controllers of different branded manufacturing machines as recited in claim 2, wherein the integrated running module automatically saves the ALARM message as an XML text file automatically, and provides the XML text file to be used by the user interface during the process of examining the ALARM, when the ALARM status occurs.

4. The method of simultaneously connecting controllers of different branded manufacturing machines as recited in claim 2, wherein after the manufacturing machine is turned on, the integrated running module accumulates the time of using the manufacturing machine through the corresponding controller automatically to perform an equipment maintenance management.

5. The method of simultaneously connecting controllers of different branded manufacturing machines as recited in claim 2, wherein after the manufacturing machine is turned on and situated at the RUN status, the integrated running module accumulates the RUN time of the corresponding controller automatically to perform a knife life management.

6. The method of simultaneously connecting controllers of different branded manufacturing machines as recited in claim 2, wherein each thread can upload a part program into the controller of the corresponding manufacturing machine.

7. The method of simultaneously connecting controllers of different branded manufacturing machines as recited in claim 1, wherein the integrated running module is coupled to a common function runtime, and after the integrated running module is integrated with each of the application program interfaces, a common application program interface is created and installed in the common function runtime, and the common function runtime includes a plug-in interface for defining a function name and a data structure of the common function runtime, and provided for users to add references and create namespace to call and use the common function runtime.

8. The method of simultaneously connecting controllers of different branded manufacturing machines as recited in claim 7, wherein after the integrated running module is connected to the predetermined manufacturing machine, a corresponding common application program interface is created in the common function runtime according to each thread, and a developer can call a function according to the function defined by the plug-in interface to introduce the data structure defined by the plug-in interface, and draft a micro application (App), and the micro application transmits the micro application to the common function runtime via a network, and the common function runtime is responsible for obtaining required information from the manufacturing machine, and the information obtained by the common function runtime is saved into the data structure defined by the plug-in interface and returned to the micro application.

9. The method of simultaneously connecting controllers of different branded manufacturing machines as recited in claim 1, wherein the integrated running module is coupled to a common function runtime, and after the integrated running module is integrated with each of the application program interfaces, a common application program interface is created and installed in the common function runtime, and an XML format is used to draft a micro application, and the micro application is transmitted to the common function runtime via a network, and after the micro application is decoded by the common function runtime, a direct communication with the integrated running module can be achieved to obtain the required information from the controller of the corresponding manufacturing machine, and after the obtained information is encoded by the common function runtime, the information is returned to the micro application.

10. The method of simultaneously connecting controllers of different branded manufacturing machines as recited in claim 1, wherein the integrated running module is coupled to a web services runtime, and the web services runtime can maintain an online status with a remote server via a network automatically, and the web services runtime can transmit the information retrieved by the integrated running module to the remote server.

11. The method of simultaneously connecting controllers of different branded manufacturing machines as recited in claim 10, wherein after the integrated running module is connected with the predetermined manufacturing machine, the web services runtime is connected to the remote server automatically and provided for a user side to start a browser to link with a web page constructed by the remote server, and after the web page selects a specific option, the message is transmitted to a service cache of the remote server and provided for the web services runtime to retrieve the service cache, and after the web services runtime obtains the information of each thread in the integrated running module, and transmits the information to the service cache of the remote server, and the information is retrieved by the user side and displayed on the web page.

12. The method of simultaneously connecting controllers of different branded manufacturing machines as recited in claim 11, wherein after the integrated running module is connected to the predetermined manufacturing machine, the web services runtime obtains information of each thread in the integrated running module automatically, and transmits the information to the service cache of the remote server, and when the remote server receives specific information, the remote server actively transmits a short message to the user side via a network.

13. The method of simultaneously connecting controllers of different branded manufacturing machines as recited in claim 12, wherein the specific information is a manufacturing machine alarm message.

14. The method of simultaneously connecting controllers of different branded manufacturing machines as recited in claim 11, wherein the user side is one selected from the collection of a desktop computer, a notebook computer, a tablet PC and a smart phone.
